(19) United States
(12) Patent Application Publication
(10) Pub. No.: US 2008/0046862 A1
(43) Pub. Date: Feb. 21, 2008

(54) Business task management

(76) Inventors: Juergen Sattler, Wiesloch (DE); Marita Kruempelmann, Dielheim (DE); Rainer Brendle, Neckargemuend (DE); Holger Meinert, Muehlhausen (DE); Cyrille Waguet, St Leon - Rot (DE); Patrick Schmidt, Heidelberg (DE); Franz Weber, Heidelberg (DE); Ulrich Keil, Heildelberg (DE)

Correspondence Address: KENYON & KENYON LLP, 1500 K STREET N.W., WASHINGTON, DC, 20005, US

(21) Appl. No.: 11/505,832

(22) Filed: Aug. 18, 2006

(51) Int. Cl. G06F 9/44

(52) U.S. Cl. 717/104

(57) ABSTRACT

Systems and methods are provided that enable synchronization and integration between business objects and user tasks. In some embodiments, the present invention allows for tight integration between business objects and tasks related to those objects. Tasks may be stored in a task “pool,” allowing multiple users to access some tasks. In Users may perform additional operations such as forwarding tasks or requesting clarification; task tracking; and technical monitoring. A task framework is provided that monitors business objects and creates, modifies, and completes tasks when appropriate changes are made to business objects.

### BACKGROUND

Task management systems allow a user to create tasks, assign tasks to other users, and track task completion for those tasks assigned to or by the user. Users may be able to set the completion status (percentage, milestone, etc.), start and due dates, status (on hold, in progress, etc.), priority, or other attributes of each task. As a user modifies or completes a task that is assigned to him, he may update the attributes of the task. Similarly, a user who assigns a task may be able to view or modify the assigned task.

However, such systems lack a way to manage tasks within a larger framework. In order for a set of tasks to be connected to an overall function, workflow or business object such as processing a purchase order, users might have to create multiple tasks and indicate that each task is part of the larger function. Similarly, when one phase of a process or function is complete, a user may have to manually create tasks associated with the next phase. In some systems, tasks may be created and assigned as part of a larger workflow. However, these systems may not provide for a separate “task workflow;” that is, a way for the tasks themselves to move through different stages, be assigned to or managed by different users, etc., where changes in the underlying business objects or processes affect the state of related tasks. There is a need for methods and systems to manage tasks in such a way as to provide close synchronization between the tasks, the actions performed by users, and the business objects to which the tasks relate.

### BRIEF DESCRIPTION OF THE DRAWINGS

FIG. 1 shows a system implementing task management according to an embodiment of the present invention.

FIG. 2 is a block diagram showing the use of tasks according to an embodiment of the present invention.

FIG. 3 is a block diagram showing user interaction with a task according to an embodiment of the present invention.

FIG. 4 is a block diagram showing various stages of a task according to an embodiment of the present invention.

FIG. 5 is a flowchart showing a task management process according to an embodiment of the present invention.

FIG. 6 is a block diagram showing a task agent framework according to an embodiment of the present invention.

FIG. 7 is a block diagram showing a task pool according to an embodiment of the present invention.

### DETAILED DESCRIPTION

The present invention provides systems and methods for connecting a user task interface with one or more backend systems implementing application and/or process logic, to provide synchronization and integration between business objects and user tasks. Such integration allows for simplified use of the system and increases features available to users. In some embodiments, the present invention allows for tight integration between business objects and tasks related to those objects. A task may be created when a business object changes, when a user explicitly creates a task, or when an application explicitly creates a task. Tasks are stored in a task “pool,” allowing multiple users to access some tasks. Storing tasks in a pool allows tasks to be aggregated, simultaneously accessible to groups of users, and filtered based on task or business object related criteria. The use of a task pool may also allow for multiple methods of distributing tasks and work loads. For example, rules may be used to control the distribution of tasks. Examples of such rules may include not offering the same task to more than one user, offering a maximum number of tasks to each user, and giving preference to tasks based on escalation time. Other rules may be used.

Tasks may be assigned to a single user for action, or a user may choose to select a task to execute. Each user may have one or more worklists, where each worklist is a user interface displaying tasks that have been assigned to the user or that are available for the user to select for execution/completion. Since business objects and tasks are tightly integrated, a user may complete a task related to a business object by altering the state of a business object or the information stored in the business object.

The integration between user-facing tasks and the backend business object framework allows for increased and streamlined functionality with respect to, for example, automatic or user-initiated task creation, modification, and completion of tasks; additional user operations such as forwarding tasks or requesting clarification; task tracking; and technical monitoring.

In a system according to the invention, a user can initiate a change in a business object, which may result in the creation, modification, and/or completion of a task. If a task is created or modified, the system may then determine the responsibility, priority, due dates, and other attributes of the task. In some embodiments, a task agent framework controls the creation, modification, and completion of tasks. A task agent framework may contain task agents and a task agent controller. A task agent may be associated with one or more business objects, such that when the business object is changed the task agent controller directs the corresponding task agents to perform any appropriate action with respect to tasks associated with the business object. The task agents may inspect or evaluate attributes of the business object or business rules based on attributes of the business object to determine whether related tasks should be created, modified, and/or completed.

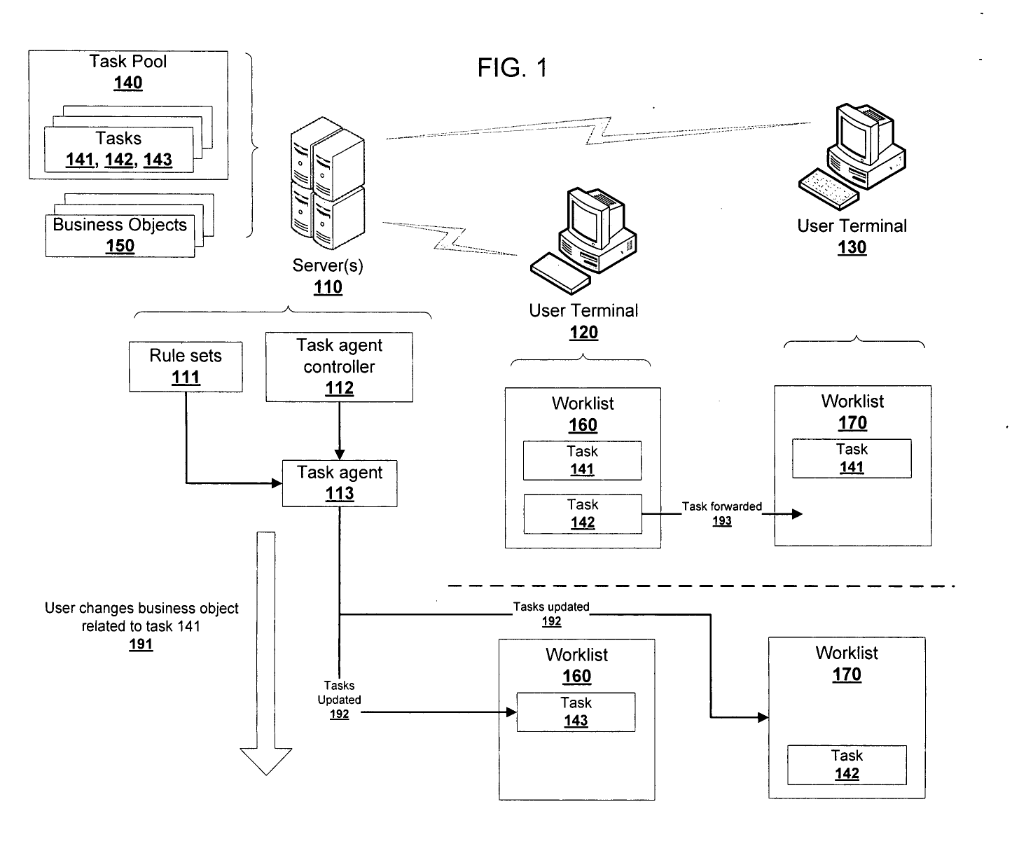

A system implementing task management according to the present invention is shown in FIG. 1. A business system has one or more servers 110 in communication with one or more user terminals 120, 130. Servers in the business system may store tasks 141, 142, 143, business objects 150, business applications, and other various objects and applications. The user terminals 120, 130 implement user interfaces to the business system. The specific arrangement and topology of servers, applications, systems, communication protocols, and connections are irrelevant to the invention unless specified otherwise herein. Within the business system, tasks may be stored in a task pool 140, described in further detail below.

A user interface can include one or more worklists 160, 170, to display tasks 141, 142, 143 assigned to a user or a group of users. Worklists are described in further detail below. A task 141 may be displayed in worklists 160, 170 of multiple users, such as when a department or group of users has responsibility for completing the task. Similarly, if only a single user has responsibility for completing a task 142, the task may be displayed only in that user's worklist 160.

Users may perform various operations on tasks. As an example, one user may forward a task 193 to another. When a task is forwarded, responsibility for completing the task may pass to the receiving user. As shown in FIG. 1, a forwarded task 142 may be displayed in the receiving user's worklist 170 and removed from the forwarding user's worklist 160 after it has been forwarded 193. As described below, a user may perform other operations on or with a task, such as asking for clarification or escalating the task.

To complete a task, a user can make a change in the corresponding business object. The appropriate business object may be indicated by the task. For example, when a user selects a task, an interface to the related business object may be displayed. As a specific example, a user may have a task that indicates a purchase order needs to be approved displayed in a worklist associated with the user. When the user selects the task, such as by clicking on it in the worklist or using another appropriate selection mechanism, an interface to the appropriate purchase order is displayed. After the user approves the purchase order, the change in the business object causes the task to be updated. FIG. 1 shows an example of a user making a change 191 in a business object related to a task 141. When the user makes the appropriate change, a task agent controller 112 in the business system may direct a task agent 113 to update any tasks associated with the business object. The task agent 113 may apply various rule sets 111 to determine which tasks to update and how the tasks should be updated. The rule sets 111 may be stored within business objects 150, or elsewhere within the business system. In embodiments using a task agent framework the rule sets may be stored in the task agent framework, for example as content of the task agent 113. In the example shown in FIG. 1, the user worklists 160, 170 are shown prior to the change in the business object (above the dotted line) and after the change in the business object (below the dotted line). The task agent 113 updates 192 appropriate tasks 141, 142, 143 based on the users' actions. A task 142 that is forwarded 193 from one user to another is removed from the forwarding user's worklist 160 and displayed in the receiving user's worklist 170. Another task 141, associated with a business object changed by a user, may be removed from: all users' worklists when a user makes an appropriate change to a business object. Similarly, the task agent 113 may create a new task 143 as a result in the change in the business object made by a user. The newly-created task may be displayed in appropriate user worklists. Various actions, task options, and task agent processes are discussed in further detail below.

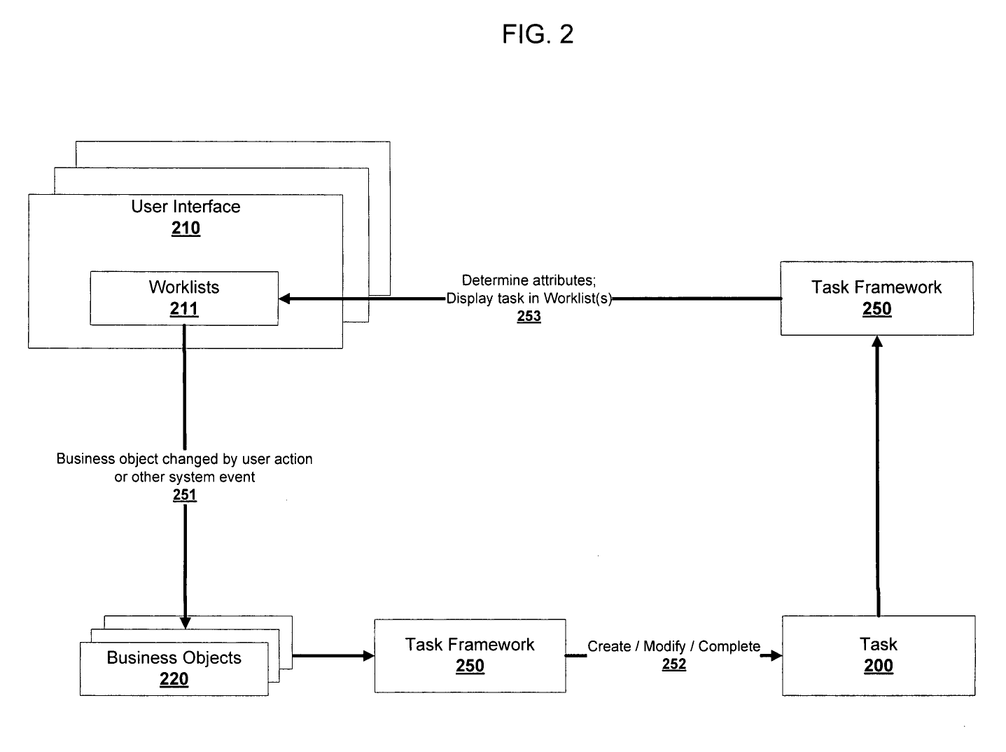

Various aspects of the present invention will now be discussed with reference to additional figures. FIG. 2 is a block diagram showing the process of task creation and completion according to an embodiment of the invention. A user interface 210 contains one or more worklists 211. The user interface may be, for example, part of an executable program installed on a computer, a browser in communication with a server, or other appropriate interface. When a business object 220 is changed by a user action, a system event, or other event 251, a task 200 in the system may be created, modified, or completed 252. For example, a business object may be associated with a rule indicating a state of the business object that should generate a task. When the business object reaches the specified state, a task is created. Similarly, a task may be updated or completed when a business object reaches a specific state.

These events may be controlled by a task framework 250. The task framework may use event-based mechanisms to invoke a task agent controller when a relevant change to a business object occurs, such as the completion of a business transaction. The business object changes may be passed to the task agent framework, which may then apply filter rules to determine whether a task agent is associated with the change. The task framework 250 may create a new task, modify an existing task, or mark an existing task as completed or canceled. If a task is created or modified, the task framework 250 may then assign attributes 253 of the created or modified task, such as a responsible user, a due date, etc. The task framework 250 may also change attributes of a preexisting task if the task has been modified as the result of a change to a business object. A task framework may include, for example, one or more task agents and task agent controllers. An exemplary task framework is described in more detail below.

After it has been modified or created, the task is displayed in the appropriate worklists 211. A task may be displayed in the worklist of a single user, or it may be displayed in multiple worklists belonging to multiple users. In some embodiments, users may have access to various different types of worklists, such as universal worklists (UWLs), to display all of a user's tasks, and object worklists (OWLs), to display tasks related to a type of business object. UWLs may aggregate tasks related to various and diverse business objects. The tasks displayed in a user's worklists may be determined dynamically. For example, the responsibility for a task may change over the lifetime of the task, such as when a user changes departments. Thus is may be useful to dynamically update the tasks displayed in a user's worklists to reflect the various tasks for which a user is responsible at a given moment. Selecting a task from a worklist allows a user to perform a range of operations on the task. In an embodiment of the invention, when a user selects a task from a worklist the task may be removed, i.e., not displayed, in the worklists of other users. Such a configuration may be used, for example, to prevent duplicate effort by multiple users. In another embodiment, “shared tasks” may be used. In such a configuration, a shared task is displayed in the worklists of all appropriate users. However, when one user begins working on the task, the task remains displayed in the other users' worklists. This may allow multiple users to simultaneously work on a task. For example, a task requiring coordination among several departments in a small time frame may be created as a shared task to enable completion of the task relatively quickly, and to allow each user or department to be apprised of the status of the task.

In another embodiment of the invention, the system may synchronize responsibility for performing a task with authorization to perform actions related to the task. For example, a task may require a change to a business record to complete. The system may ensure that the users responsible for completing the task have appropriate authorization or permission within the system to modify the business record.

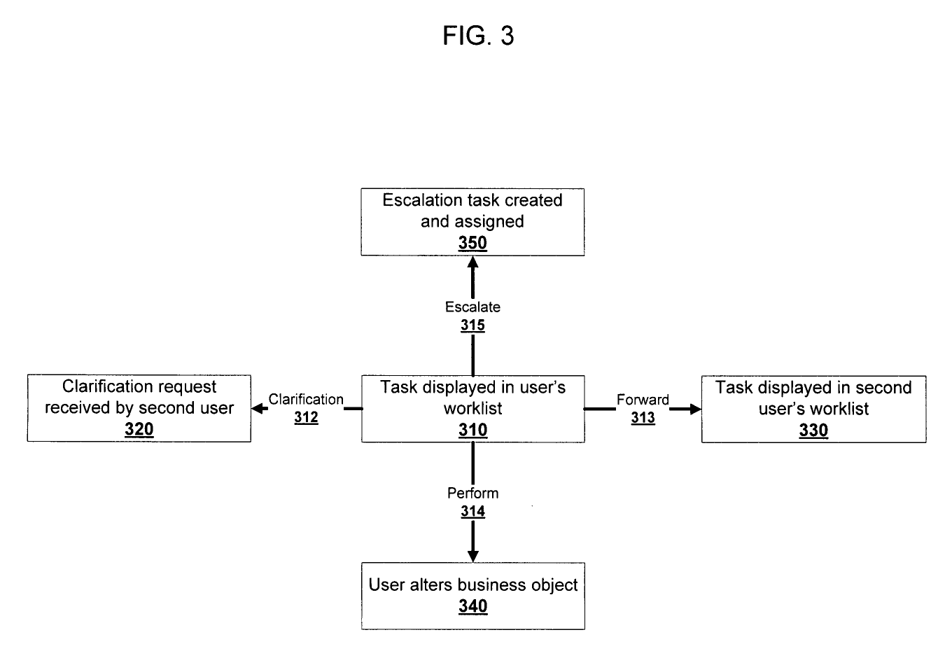

FIG. 3 shows example operations that a user may perform on a task. A task is first displayed in a user's worklist 310. The task may have been, for example, assigned by another user, or created in response to a system event such as a change in a business object. If the user requires more information about the task, he may request clarification 312. Doing so may send a new task to the appropriate user 320, for example the user who assigned the initial task. When the clarification task is completed, information about the original task may be communicated to the user who requested clarification.

The user may forward the task 313 to another user. The task is then displayed in the receiving user's worklist 330. In some embodiments, the forwarded task may be displayed in the original user's worklist, for example to allow the original user to track progress of the task. In other embodiments, the task is only displayed in the receiving user's worklist.

The user may escalate the task 315. Doing so may forward the original task or create a new task that is sent to an appropriate user, such as the original user's manager or supervisor. The escalation task is then displayed in the receiving user's worklist 350. A task may also be escalated by the system without user intervention, such as if a deadline or time limit is exceeded. When an “escalation task” has been performed, the original task may be marked as completed, or it may be returned to the original user, for example with additional instructions from the user who completed the escalation task.

A user may also “perform” the task 314. To do so, the user makes an appropriate change to a business object associated with the task 340. For example, a task might be generated when a purchase order business object reaches a state indicating that the order requires approval. When the appropriate user approves the order, the state of the business object is changed and the task is completed. When the business object is altered, the system may mark the task as complete, and no longer display it in the user's worklist. The system may also create or modify additional tasks, as previously described.

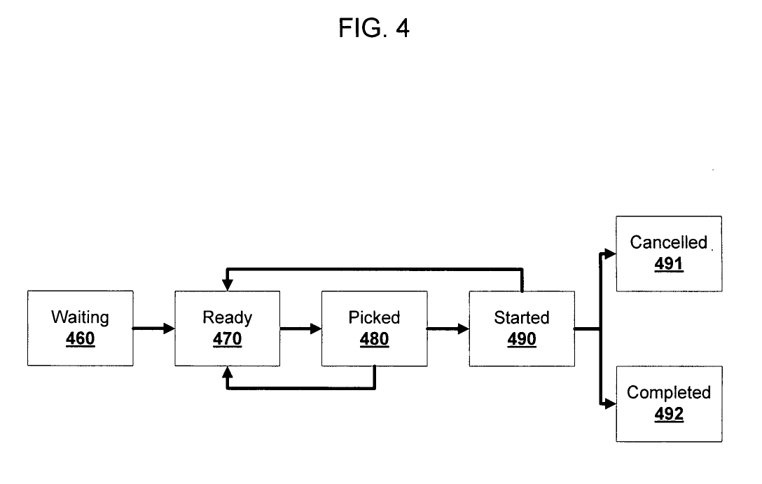

FIG. 4 shows the progression of a task through various states task according to an embodiment of the present invention. As previously described, tasks are created in response to user actions such as escalation of another task or modification of a business object; in response to a change in a business object; and when directly created by the system. A task is initially created in the “waiting” or “ready” state 460. The “waiting” state can be used, for example, if a task is created with an activation date (i.e., the task cannot be acted on by a user until a specific date). If a task begins in the waiting state 460, it may later be moved into the “ready” state 470. For example, if a task cannot be acted on until a specific date, the task will be moved into the “ready” state when that date is reached.

Most tasks will be created in the “ready” state 470, indicating that operations may be performed on the task. When a task is in this state it may be displayed in one or more user worklists, indicating that a user may perform operations on the task, such as those operations previously described with respect to FIG. 3. When a user selects a task from a worklist, the task will be placed in the “picked” state 480 and the user is assigned as processor of the task. Responsibility for the task may be assigned to the user, or it may remain with another user or group of users as initially determined by the system. A task in the “picked” state may still be displayed in worklists other than those of the user who selected the task, for example to allow a user's supervisor to track progress of the task. It may also be displayed only in a single user's worklist. In some embodiments, a task may be placed directly into the “picked” state 280, for example when it is directly assigned to a single user based on rules in the system. In the case of a shared task as described above, a task may not be placed in the “picked” state when selected by a user, allowing other users to work on the task simultaneously.

A user can also “put back” a task, which will place the task in the “ready” state 470 again. This may be useful, for example, where responsibility for a task has been assigned to a group of users. When a first user in the group selects such a task from a worklist, it may be removed from the worklists of other users in the group. If a user puts the task back, it will again be displayed in the worklists of other users in the group, allowing a different user to select it. In some embodiments, a task pool allows a group or groups of users to track and view tasks that have been selected by other users. A task pool is described in further detail below.

After a user selects a task, the task may be set to the “started” state 490. In some embodiments, tasks may be placed directly from the “ready state” 470 into the “started” state 490 when selected by a user. When a task is placed in the “started” state 490, a user interface appropriate to the task may be launched. For example, a task requiring a user to enter customer information might display a customer record allowing the user to update customer information when the task is placed in the “started” state 490. Once a task has been started, a user may return it to the “ready” state 470 by putting the task back as previously described.

When a user completes the action(s) associated with a task, the task may be placed into the “completed” state 492. This can happen automatically, for example when appropriate changes are made to a business object with which the task is associated, or when a user indicates the task is complete. As previously described, when a business object is modified the system may complete a task (i.e., place it in the “completed” state 492). In the case of a shared task, the system also may place a task into the “completed” state 492 when it receives an acknowledgement or other message from the users responsible for the task.

A task may be set to the “canceled” state 491 if a user indicates the task should be canceled or if, for example, it passes its expiration date. The system may also set other conditions that result in the task being cancelled, such as if the associated business task enters a state rendering the task obsolete. In some embodiments, completed and canceled tasks will be kept in the system. This allows for comprehensive tracking and technical monitoring of tasks, the related business system, and the interface between the two. Completed and cancelled tasks may be archived, and access may be restricted to a group of users, developers, or other personnel. This allows for data to be extracted from the tasks without requiring all users to manage old tasks.

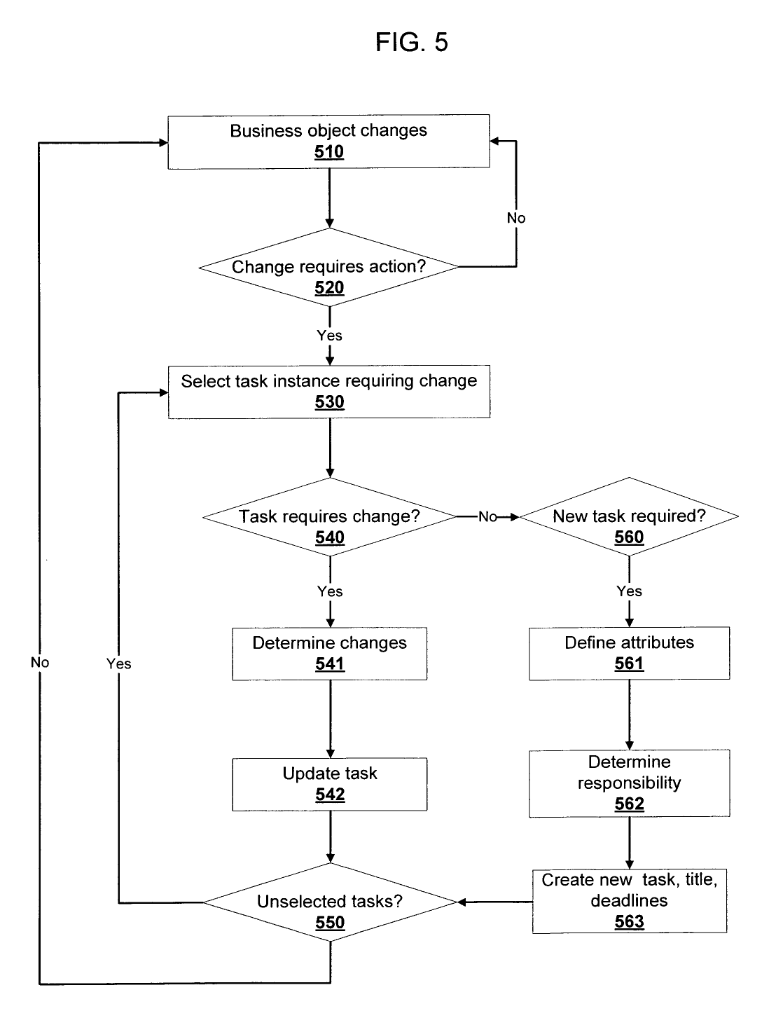

In some embodiments, the system includes task agents and task agent controllers to manage tasks. The set of task agents and/or task agent controllers in a system according to the invention may be referred to as a “task framework” of the system. A task agent is a program that monitors a business object or a set of business objects (such as those of a particular type), and creates, modifies, and completes appropriate tasks when business objects change state. For example, a task agent may place tasks into the various states described with respect to FIG. 4. In general, the logic required to create, modify, complete, and otherwise affect tasks may be stored in the task framework, such as within individual task agents. Task agents may analyze data stored in business objects or elsewhere in the business system when determining appropriate actions to perform on a task. FIG. 5 shows an exemplary process implemented by a task agent according to an embodiment of the present invention. In some embodiments, additional steps not shown that are specific to the backend implementation may be performed.

When the state of a business object changes 510, the task agent framework determines if the business object requires an action of the task agent such as creating a new task or modifying an existing task 520. In some embodiments, the task agent may compare the state of the business object to a previously-known state, compare rule sets in the business system, or use other data to determine whether the selected business object requires an action.

The task agent may be associated with a single business object or business object type. Similarly, a business object may notify a relevant task agent when the state of the business object changes. If no action is required and other relevant business objects exist, the task agent selects another business object for examination 510. If one or more actions are required with respect to the newly-selected business object, the task agent selects any task instances associated with the business object that need to be modified in response to the change in the business object 530. This may allow the task agent to perform later operations on the tasks, such as setting the task to a different state.

For each task instance selected, the task agent may evaluate the task 540 to determine whether it has to be modified, canceled, or completed. Similarly, it determines if a new task needs to be created 560. These determinations can be made by examining the state of the associated business object. For example, each business object may store a list of states or state changes that should invoke a new task or initiate a change in an existing task, and the tasks or types of tasks that should be created or modified. If a business object enters a state matching a listed state, the task agent may take the appropriate action. Similarly, the task agent may consult a rule set stored in the business object or the business system to determine what action is required.

For each task that needs to be modified, the task agent next determines the appropriate change 541. For example, a task that requires a user to enter information in a customer record may be moved to a completed state after the user makes the appropriate modification to the customer record business object. The task agent then updates the task by placing it into the appropriate state 542. If a new task should be created in response to a change in a business object, the task agent selects the attributes, such as priority, importance, or security level, to assign to each task 561. These attributes may be default values associated with a task type, values given by the associated business object, or calculated from other information. Next, responsibility for the task is determined and associated with the task 563. For example, the task type may dictate that a user, group of users, or user type should be responsible for the task. As previously described, a task is displayed in the worklists of the user or users assigned responsibility for the task. Similarly, a title and/or appropriate deadlines may be calculated 563 and attached to the new task. This information may be retrieved directly from attributes of the associated business object, or it may be calculated by the task agent from other data. Information about creations, modifications, completions and cancellations may be recorded to enable technical monitoring and troubleshooting of the task system.

At each step, the task agent may consult and apply rules and/or rule sets to determine if a task should be created, updated, or completed, or if other actions are necessary. The rules may be stored in the backend system, the business objects, or the task framework. Rules may be created by business experts, developers, and/or end users. For example, rules that apply regardless of the specific system in which the task framework is implemented may be defined by business experts and/or developers, whereas rules specific to a particular business system may be defined by end users. The various decisions shown in FIG. 5, such as whether a task requires a change 540 and whether a new task is required 560, may be made using logic and/or rules stored in the task agent. In some embodiments, business objects do not store, apply, or provide task-related logic.

Some embodiments of the invention may include one or more task agent controllers. In some embodiments, a single task agent controller may be used. In other embodiments, there may be multiple task agent controllers. A new instance of a task agent controller may be created when task agent functionality is required by an application. In general, a task agent controller monitors business objects and activates the appropriate task agent when a business object is modified. When a business object is modified, the task agent controller selects an appropriate task agent based on the business object, the type of business object, and/or the type of modification. The task agent controller activates the selected task agent or creates an instance of the task agent, and may transfer information about the business object and/or the modification to the task agent for processing. The task agent then proceeds as described above.

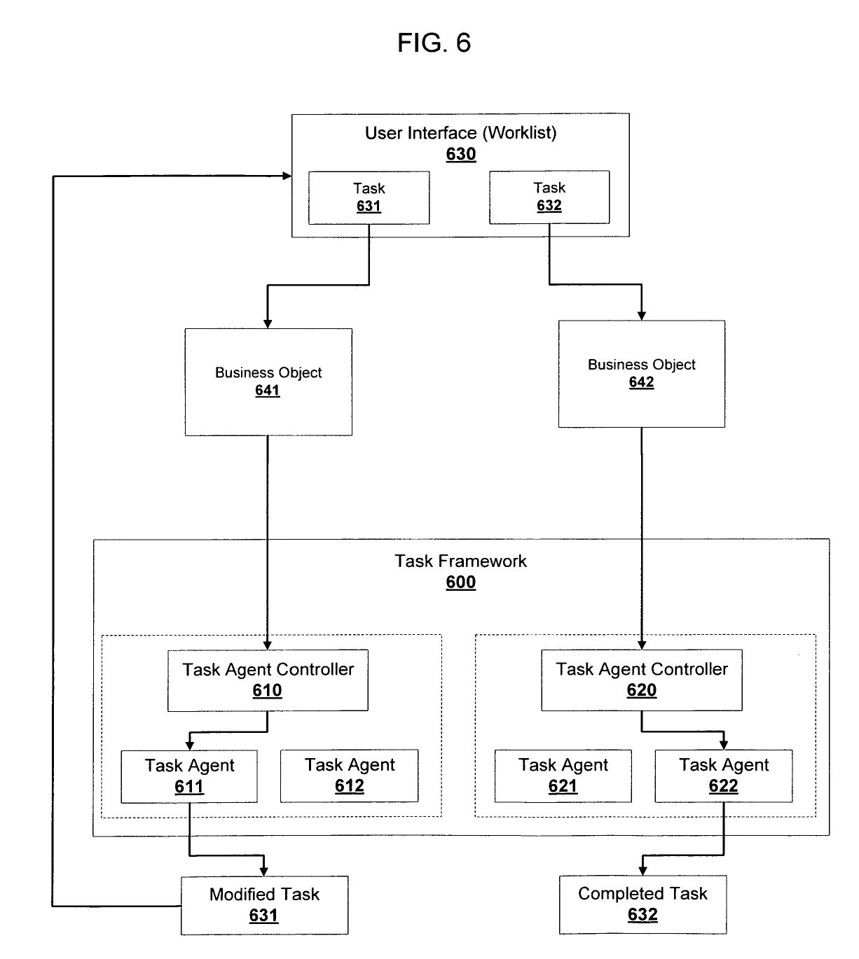

FIG. 6 shows a task agent controller according to an embodiment of the present invention. A user interface 630, such as a worklist, may display tasks 631, 632 that the user is responsible for completing. The user may complete the tasks by making appropriate changes in business objects 641, 642 related to those tasks. The process of selection and completion of tasks has been previously described.

In some embodiments, the business system includes a task framework 600.

The task framework 600 may include one or more task agent controllers 610, 620, each of which may be associated with task agents and/or business objects or types of business objects. The task agent controllers 610, 620 may be instances of a single task agent controller. In the example shown, a first task agent controller 610 is associated with a first business object 641 and two task agents 611, 612. One of the task agents 611 is associated with the first business object 641 or a type or group of business objects to which the business object 641 belongs. For example, the task agent 611 may be associated with purchase order business objects, and the business object 641 may be an instance of a purchase order. When the task agent controller 610 detects a change in the business object 641, it may direct the related task agent 611 to take any appropriate action with respect to tasks associated with the business object. An exemplary process used by a task agent to do so was previously described with respect to FIG. 5. For example, the task agent 611 may determine that the business object 641 is in a state that requires the originating task 632 to be created. The task agent therefore modifies the task 632, which is then displayed in the appropriate user interface 630. In the example shown in FIG. 6 the modified task 632 is displayed in the current user interface 630, but it could be displayed in any user interface associated with a user responsible for completing the new task 650.

As another example, a second task agent controller 620 may control two task agents 621, 622. One of the task agents 622 may be associated with the second business object 642. When a user makes a change in the business object 642 based on a task 632, the task agent controller 620 may direct the related task agent 622 to take any appropriate action. In the example, the change in the business object 642 indicates that the task 632 should be completed. The task agent 622 therefore places the task 632 into a “completed” state. The task may then be archived or otherwise stored as previously described.

The task framework 600 may have many task agent controllers and task agents. In some embodiments, a single task agent controller will be used, with instances of the task agent controller created as required. Each task agent may be related to a specific business object, or a task agent may be related to a group of business objects or a specific type of business objects. Similarly, task agent controllers may be associated with one or more business objects, groups, or types. Each of the task agents and/or task agent controllers may monitor business objects as previously described with respect to FIG. 5.

Additional functionality may be available to users due to the integration of business objects and tasks, where tasks may inherit some properties of related business objects. For example, users may track tasks that have been assigned to them, that they have assigned to other users, or in which they have been involved (such as via an escalation, clarification, or forward). There may be additional actions users can perform on or with tasks. For example, tasks may include attachments such as documents, spreadsheets, or text notes; users may add, remove, modify, and view such attachments.

In an embodiment of the present invention, tasks are stored in a task pool. In such an embodiment, a business system comprises one or more task pools, where a task pool stores multiple tasks. Although a task may be associated with a specific user or users, the task is stored in a general repository holding the set of tasks available within the system. A task pool may also hold a set of related tasks, such as those assigned to a specific group of users or those related to a specific type of business object. For example, a business system may have a single task pool. All tasks, regardless of whether they are assigned to a user, a group of users, or to no user, are stored in the task pool. When a user is assigned to a task, selected as the responsible user, has a task forwarded to him from another user, or is otherwise associated with the task, a task instance representing that task may be displayed in his worklist. However, the task itself is still stored in the task pool. Thus another user may be able to view and/or manipulate the task. As another example, when a group of users is assigned responsibility for the task, a related task instance may be displayed in a worklist belonging to each member of the group. Once a member of the group completes the task, it will be removed from all worklists displaying the task.

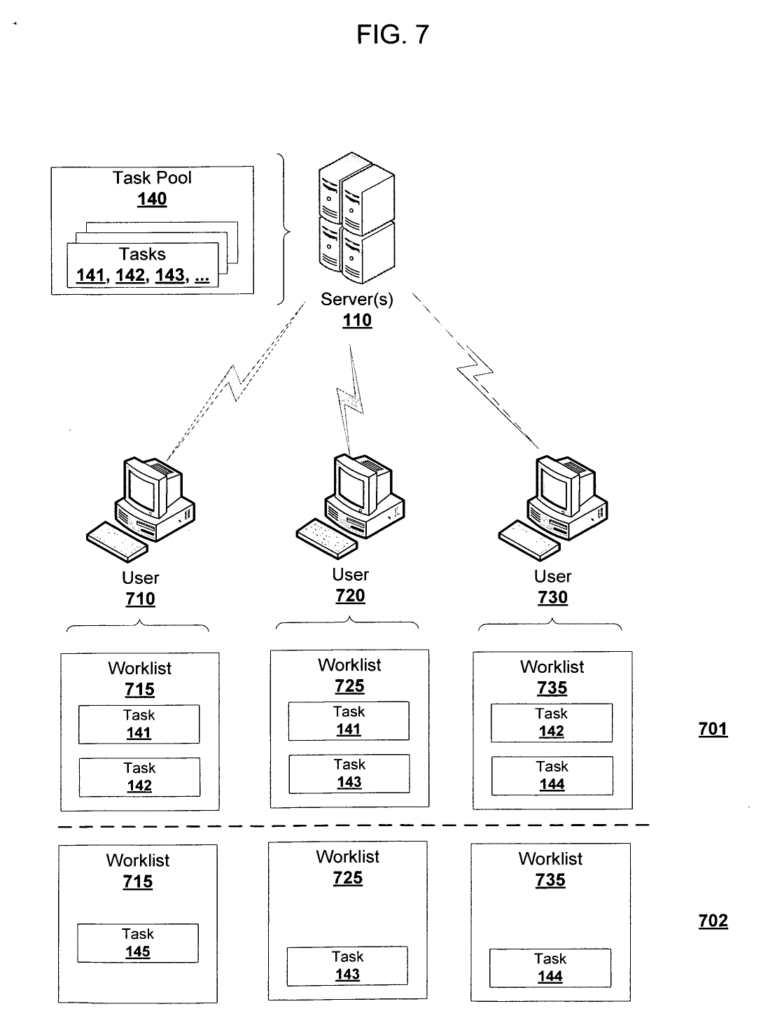

An exemplary system using a task pool according to an embodiment of the invention is shown in FIG. 7. A business system contains one or more servers 110 for storing business objects, tasks 141, 142, 143, as previously described. Users 710, 720, 730 may access the business system via, for example, worklists 715, 725, 735, respectively, which display any tasks associated with each user. The operation of worklists and user terminals is similar to that discussed previously. FIG. 7 shows the worklists of three users at two points in time, 701 and 702. At time 701, each user has two task instances displayed in his worklist. These task instances correspond to tasks stored in a task pool 140 on the business system. The task pool 140 may be a single large task pool for the entire business system, or it may be one of many task pools. For example, the three users 710, 720, 730 may all be members of a single user group, which has a task pool associated with it. Some tasks 141, 142 are displayed in multiple users' worklists. A task may be displayed in multiple users' worklists if either user may complete the task, if a group to which the users belong has responsibility for completing the task, or if the users have chosen to display the task, such as for tracking purposes. Other situations, as previously discussed, may also result in a single task being displayed in multiple worklists.

After the initial time 701, a user 710 completes two tasks 141, 142 by making appropriate changes to business objects related to the tasks. Such task completion has been discussed previously. After completing the tasks, the user 710 may be assigned another task 145 at time 702. The previously-completed tasks 141, 142, are no longer displayed in the other users' worklists 725, 735. The completed tasks may still be stored in the business system for future use.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A method for managing tasks in a multi-user system, comprising:
in response to a change in a business object, creating a new task;
assigning an attribute to the task, the attribute being defined by data stored in the business object;
assigning the task to a user responsible for completing the task; and
displaying the task in a worklist associated with the user responsible for completing the task.

2. The method of claim 1, further comprising:
in response to a user selection of the task displayed in the worklist, displaying a user interface allowing the user to change a business object associated with the task; and
in response to a change in the business object associated with the task, placing the task in a completed state.

3. The method of claim 2, further comprising:
in response to the change in the business object associated with the task, if the business object is associated with a rule specifying a new task should be created, creating the new task; and
if a new task is created, displaying the task in a worklist associated with the user responsible for completing the task.

4. The method of claim 1 wherein the task is stored in a task pool.

5. The method of claim 4 wherein the task is displayed in a worklist associated with each member of a group of users responsible for completing the task.

6. The method of claim 1 wherein the task is a shared task.

7. The method of claim 1, further comprising:
in response to a user forwarding the task to a second user, removing the task from the user's worklist and displaying the task in a second worklist associated with the second user.

8. A task framework, comprising:
a task agent controller to monitor business objects for changes of state and direct a task agent;
a task agent to create, modify, and mark tasks as complete based on changes to business objects;
wherein the task agent is associated with one or more business objects or types of business objects.

9. The task framework of claim 8 wherein the task agent identifies a user responsible for completing a task and causes the task to be displayed in a user interface associated with the user.

10. The task framework of claim 8 wherein the task agent assigns identifies a group of users responsible for completing a task and causes the task to be displayed in a user interface associated with each user in the group.

11. A method of managing tasks, comprising, for a business object:
selecting tasks associated with the business object;
for each task:
comparing the state of the business object to a list of business object states and task operations;
if the business object is in a state associated with a task operation, performing the operation on the task; and
if the task is not in a completed or canceled state, displaying the task in a worklist associated with a user responsible for the task.

12. The method of claim 11, further comprising:
if the business object is in a state requiring a new task to be created, creating the new task; and
in response to creation of a new task, assigning the task to a user and displaying the task in a worklist associated with the user.

13. A system comprising:
a business system to store business objects and tasks;
a task framework to manage tasks; and
a plurality of user terminals to display user interfaces;
wherein when a user alters a business object via a user interface, the task framework creates a new task if the altered business object is associated with a rule specifying that a new task should be created.

14. The system of claim 13 wherein the new task is assigned to a user and displayed in a worklist in the user interface associated with the user.

15. A machine-readable medium containing program instructions for execution on a processor, which when executed cause the processor to perform:
in response to a change in a business object, creating a new task or modifying an existing task;
assigning the task to a user responsible for completing the task; and
displaying the task in a worklist associated with the user responsible for completing the task.

16. A machine-readable medium containing program instructions for execution on a processor, which when executed cause the processor to perform:
monitoring a business object to detect a change in the state of the business object; and
in response to a change of state of the business object, causing a task agent to create, modify, or complete a task related to the business object.
